(19) United States
(12) Patent Application Publication
(10) Pub. No.: US 2012/0103308 A1
(43) Pub. Date: May 3, 2012

(54) Two-Way Valve Orifice Plate for a Fuel Injector

(75) Inventors: Gregory W. Hefler, Chillicothe, IL (US); Avinash R. Manubolu, Edwards, IL (US); Bryan D. Moore, Washington, IL (US)

(73) Assignee: Caterpillar, Inc.

(21) Appl. No.: 12/914,572

(22) Filed: Oct. 28, 2010

(51) Int. Cl. F02M 63/00; B05B 1/30

(52) U.S. Cl. 123/447; 239/584

(57) ABSTRACT

A pressure balancing orifice plate for a fuel injector device may include a cylindrical body having a top surface, a bottom surface, an annular outer surface, and a body longitudinal axis, a balance pressure relief orifice extending from the top surface to the bottom surface, and a raised valve seat extending upwardly from the top surface and surrounding the balance pressure relief orifice. The valve seat may have a central seat surface encircling the balance pressure relief orifice and a plurality of leaf portions extending radially outwardly from the central seat surface and defining drainage channels there between. A width W_{C} of the drainage channels may increase as the radial distance from the balance pressure relief orifice increases.

### TECHNICAL FIELD

This disclosure relates generally to fuel injection systems, and in particular to a two-way valve orifice plate having a raised valve seat configured to facilitate fluid drainage.

### BACKGROUND

Internal combustion engines using injectors associated with each cylinder are known. A typical fuel injector includes various valves and valve arrangements operating to inject fuel into the cylinder in a controlled fashion. These valves are controlled, typically, by electronic actuators associated with each fuel injector. Each fuel injector is capable of injecting a quantity of fuel into a cylinder of an internal combustion engine at pre-determined times and for pre-determined durations. A typical injector is positioned beneath the valve cover of the engine and in direct fluid communication with the cylinder. During operation, electrical signals sent to the fuel injector actuate a valve that injects fuel into the cylinder.

Common rail fuel systems typically employ multiple fuel injectors to inject high-pressure fuel into the combustion chambers of an engine. Each of these fuel injectors may include a nozzle assembly having a cylindrical bore with a nozzle supply passageway and a nozzle outlet. A needle check valve may be reciprocatingly disposed within the cylindrical bore and biased toward a closed position where the nozzle outlet is blocked. In response to a deliberate injection request, the needle check valve may be selectively moved to open the nozzle outlet, thereby allowing high-pressure fuel to flow from the nozzle supply passageway into the combustion chamber.

Typically, a spring biases the needle of the injector toward a closed position. Periodically, an actuator actuates to move the needle or to otherwise allow the needle to move to an open or injection position to dispense a predetermined amount of fuel into the combustion chamber. In one type of fuel injector, high-pressure fuel is pumped into the injection chamber from a high-pressure fuel source, such as a common rail, with the fluid creating a force tending to lift the needle against the force of the spring. To prevent the needle from moving, high-pressure fuel is also provided to a pressure balancing reservoir disposed at an end of the needle opposite the injection orifices to balance the force applied by the high-pressure fuel in the injection chamber. At the appropriate time, an actuator mechanism opens a valve to drain the high-pressure fuel from the pressure balancing reservoir and allow the needle to move to the open position and inject fuel into the combustion chamber.

One example of this type of fuel injector is provided in U.S. Pat. No. 5,803,369, issued Sep. 8, 1998. High-pressure fuel is present in a pressure control chamber, with a solenoid valve lifting a spherical member off of an annular seat face of a flat plate to release the pressure in the pressure control chamber. The high-pressure fuel flows from the pressure control chamber through a restrictor hole through the flat plate, over the annular seat face and into an annular groove passage, and outwardly through radial fuel groove passages. With the pressure released, a nozzle needle may move upwardly so that the high-pressure fuel is discharged through close injection holes. In the embodiment shown in FIGS. 1-8, the annular groove passage of the flat plate includes raised surfaces facing the annular seat face having generally convex inner walls with respect to the seat face. As the high-pressure fuel flows across the annular groove passage, cavitation occurs due to the impingement of the flowing fuel on these inner walls of the annular groove passage. Over time, the cavitation may cause structural damage to the raised surfaces of the flat plate and create debris that affects the performance of the fuel injector. Therefore, a need exists for a new technology for valve orifice plates that may allow high-pressure fuel to be drained from a pressure control chamber without causing damage to the orifice plate due to cavitation of the draining fuel.

### SUMMARY OF THE DISCLOSURE

In one aspect, the invention is directed to a pressure balancing orifice plate for a fuel injector device. The orifice plate may include a cylindrical body having a top surface, a bottom surface, an annular outer surface, and a body longitudinal axis, a balance pressure relief orifice extending from the top surface to the bottom surface, and a raised valve seat extending upwardly from the top surface and surrounding the balance pressure relief orifice. The valve seat may have a central seat surface encircling the balance pressure relief orifice and a plurality of leaf portions extending radially outwardly from the central seat surface and defining drainage channels there between. A width W_{C} of the drainage channels may increase as the radial distance from the balance pressure relief orifice increases.

In another aspect, the invention is directed to a fuel injector the may include a check needle for controlling flow of fuel into a combustion chamber, a pressure balancing reservoir having pressurized fuel therein that urges the check needle toward a closed fuel blocking position, and a control valve assembly. The control valve assembly may include a pressure balancing orifice plate that may have a balance pressure relief orifice extending from a top surface to a bottom surface of the pressure balancing orifice plate, and may have a raised valve seat extending upwardly from the top surface and surrounding the balance pressure relief orifice. The balance pressure relief orifice may be in fluid communication with the pressure balancing reservoir, and the raised valve seat may have a central seat surface encircling the balance pressure relief orifice and a plurality of leaf portions extending radially outwardly from the central seat surface and defining drainage channels there between. The control valve assembly may further include a valve member that may have a planar surface configured to engage the raised valve seat and form a seal there between to prevent fluid flow through the balance pressure relief orifice. The valve member may selectively control a flow of pressurized fuel from the pressure balancing reservoir to a drain so that the pressurized fuel maintains the check needle in the closed fuel blocking position when the valve member forms the seal between the valve member and the valve seat. The pressurized fuel may drain through the balance pressure relief orifice to allow the check needle to move to an open fuel injection position when the valve member is disengaged from the valve seat.

In a further aspect, the invention is directed to a fuel injector system for use in an internal combustion engine. The fuel injector system may include a high-pressure fuel source, an injection chamber in fluid communication with the high-pressure fuel source, a check needle for controlling flow of pressurized fuel from the injection chamber into a combustion chamber, a pressure balancing reservoir in fluid communication with the high-pressure fuel source, wherein pressurized fuel therein urges the check needle toward a closed fuel blocking position, and a control valve assembly. The control valve assembly may include a pressure balancing orifice plate that may have a balance pressure relief orifice extending from a top surface to a bottom surface of the pressure balancing orifice plate, and may have a raised valve seat extending upwardly from the top surface and surrounding the balance pressure relief orifice. The balance pressure relief orifice may be in fluid communication with the pressure balancing reservoir, and the raised valve seat may have a central seat surface encircling the balance pressure relief orifice and a plurality of leaf portions extending radially outwardly from the central seat surface and defining drainage channels there between. The control valve assembly may further include a valve member that may have a planar surface configured to engage the raised valve seat and form a seal there between to prevent the pressurized fuel from flowing through the balance pressure relief orifice. The valve member may selectively control flow of pressurized fuel from the pressure balancing reservoir to a drain so that the pressurized fuel maintains the check needle in the closed fuel blocking position when the valve member forms the seal between the valve member and the valve seat, and the pressurized fuel may drain through the balance pressure relief orifice to allow the check needle to move to an open fuel injection position when the valve member is disengaged from the valve seat.

Additional aspects of the invention are defined by the claims of this patent.

### BRIEF DESCRIPTION OF THE DRAWINGS

FIG. 1 is a sectional view a fuel injector incorporating a two-way valve orifice plate in accordance with the present disclosure;

FIG. 2 is an enlarged sectional view of a portion of the fuel injector of FIG. 1 including the two-way valve orifice plate;

FIG. 3 is a perspective view of the spherical member of the two-way valve of the fuel injector of FIG. 1;

FIG. 4 is a top view of the two-way valve orifice plate of the fuel injector of FIG. 1;

FIG. 5 is a top view of the valve seat and first valve body seat of the two-way valve orifice plate of FIG. 3;

FIG. 6 is a top view of an alternative embodiment of a two-way valve orifice plate of the fuel injector of FIG. 1; and

FIG. 7 is a top view of the valve seat and first valve body seat of the two-way valve orifice plate of FIG. 6.

### DETAILED DESCRIPTION

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

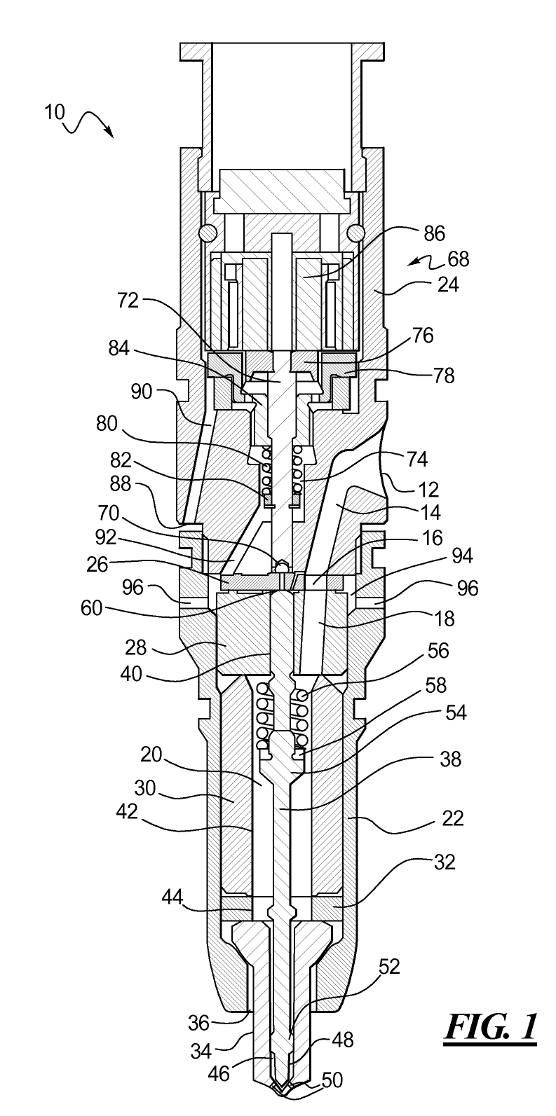

FIG. 1 illustrates an example of a fuel injector 10 that may implement a valve orifice plate in accordance with the present disclosure. The fuel injector may receive high-pressure fuel from a pressurized fuel source, such as a common rail, at a high-pressure fuel inlet 12. High-pressure fuel at the fuel inlet 12 may flow through a series of high-pressure fuel passages 14-18 and into an injection chamber 20 within a nozzle case 22. Depending on the specific configuration of the fuel injector 10, the high-pressure fuel passages 14-18 may be formed in a corresponding plurality of components of the fuel injector 10, such as a valve body 24, pressure balancing orifice plate 26 and check guide plate 28, respectively.

Within the nozzle case 22, a check sleeve 30 may be disposed and further define the injection chamber 20. The check sleeve 30 may extend between the check guide plate 28 and a check lift spacer 32, with the check lift spacer 32 engaging a nozzle tip 34 extending out of a nozzle opening 36 of the nozzle case 22. When the fuel injector 10 is assembled, the entire stack composed of the orifice plate 26, the check guide plate 28, the check sleeve 30, the check lift spacer 32 and the nozzle tip 34 may be together into sealing engagement to form seals preventing leakage of the high-pressure fuel from the fuel injector 10 when the valve body 24 is attached to the nozzle case 22. The check guide plate 28, check sleeve 30, check lift spacer 32 and nozzle tip 34 may have axial bores 40-46 in which a check valve stem 38 is disposed.

The axial bore 40 of the check guide plate 28 may have an inner diameter slightly larger than an outer diameter of an upper portion of the check valve stem 38 such that the upper portion fits snuggly within the axial bore 40 and is guide by the axial bore 40 so that check valve stem 38 may move up and down axially within the injection chamber 20. In contrast, the axial bores 42, 44 of the check sleeve 30 and check lift spacer 32, respectively, may have larger inner diameters than an outer diameter of a central portion of the check valve stem 38 so that the injection chamber 20 has the necessary volume for high-pressure fuel for the proper operation of the fuel injector 10. The axial bore 46 of the nozzle tip 34 may have a smaller inner diameter than the axial bores 42, 44, but still provide an annular space between the axial bore 46 and a needle 48 of the check valve stem 38 disposed therein to allow high-pressure fuel to flow to injection orifices 50 of the nozzle tip 34. The tip of the needle 48 and end of the nozzle tip 34 may be configured to form a seal when the needle 48 engages the end of the nozzle tip 34 to prevent fuel flow through the injection orifices 50. Upward movement of the check valve stem 38 disengages the needle 48 from the end of the nozzle tip 34 to allow fuel to be injected into the combustion chamber. An annular shoulder 52 of the needle 48 having an outer diameter slightly smaller than the inner diameter of the axial bore 46 aligns the needle 48 within the nozzle tip 34 while allowing fuel to flow to the injection orifices 50, perhaps with the aid of grooves, orifices or other flow channels formed therein.

The central portion of the check valve stem 38 disposed within the check sleeve 30 includes an upper annular shoulder 54 having an outer diameter smaller than the inner diameter of the axial bore 42 to allow the flow of fuel through the injection chamber 20. A spring 56 disposed between the annular shoulder 54 and the bottom surface of the check guide plate 28 provides a force biasing the check valve stem 38 toward the nozzle tip 34 so that the needle 48 forms the seal preventing fuel from exiting the injection orifices 50. If necessary, a spacer 58 having an appropriate thickness may be placed between the spring 56 and the upper surface of the annular shoulder 54 to control the compression of the spring 56.

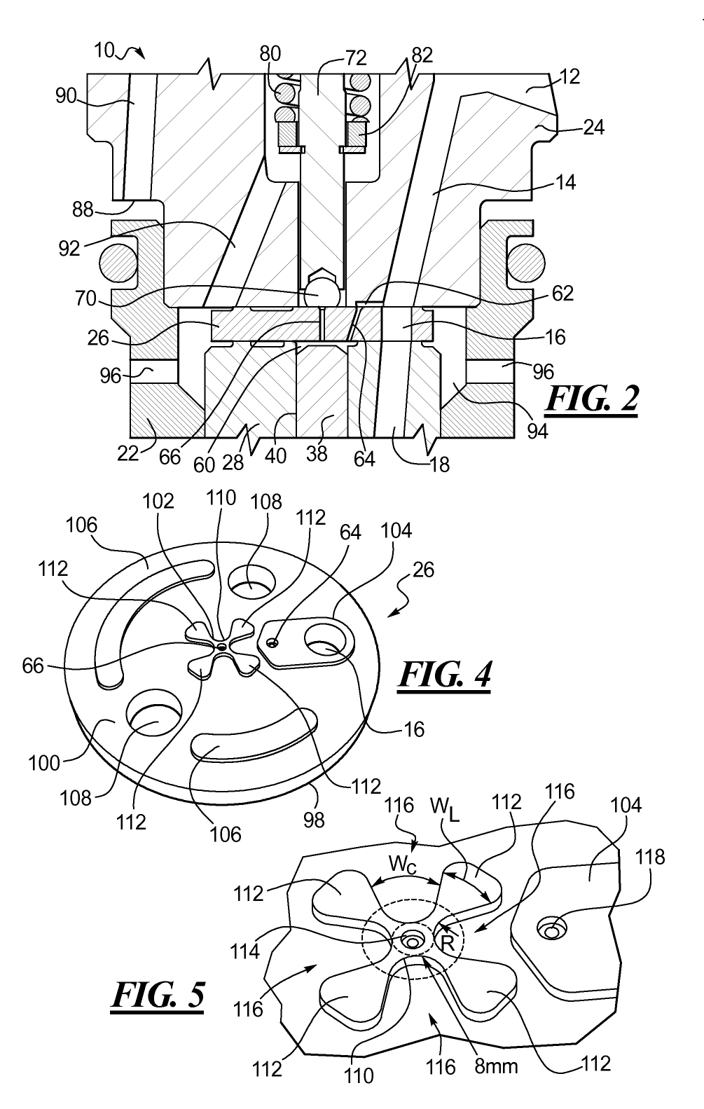

To keep the check valve stem 38 seated until the appropriate time to inject the fuel into the combustion chamber, a pressure balancing reservoir 60 that will be charged with the pressurized fuel is provided at the upper end of the axial bore 40 of the check guide plate 28. Referring to FIG. 2, a central portion of the fuel injector 10 is shown. The pressure balancing reservoir 60 is formed at the upper end of the axial bore 40 and is defined by the inner wall of the axial bore 40, raised seating surfaces of the check guide plate 28, the end of the check valve stem 38, and a bottom surface of the orifice plate 26. High-pressure fuel is diverted from the high-pressure fuel passages 14, 16 by a high-pressure fuel balancing passage 62 formed in a bottom surface of the valve body 24. The high-pressure fuel balancing passage 62 extends to an opening of a balance pressure orifice 64 extending through the orifice plate 26. The high-pressure fuel balancing passage 62 and balance pressure orifice 64 place the pressure balancing reservoir 60 in fluid communication with the high-pressure fuel inlet 12.

At the same time high-pressure fuel is provided to the injection chamber 20, the pressure balancing reservoir 60 is pressurized with the high-pressure fuel. While the check valve stem 38 is seated and the pressure balancing reservoir 60 is pressurized as shown in FIG. 1, the fuel injector 10 will remain closed until the pressure is released from the pressure balancing reservoir 60. The injection chamber 20 and pressure balancing reservoir 60 are exposed to the same high-pressure fuel provided at the high-pressure fuel inlet 12, but a net force due to the pressure in the downward direction exists to maintain the seating of the needle 48 because a portion of the needle 48 below the seat is not exposed to the high-pressure fuel. For example, in one embodiment the diameter of the portion of the check valve stem 38 within the axial bore 40 may be approximately 5.0 mm (approx. 0.197 in.) and the valve seat between the needle 48 and the nozzle tip 34 may be circular and have a diameter of approximately 2.7 mm (approx. 0.106 in.). As a result, the pressurized fuel in the pressure balancing reservoir 60 acts on a hydraulic surface area perpendicular to a longitudinal axis of the check valve stem 38 of approximately 19.6 mm² (approx. 0.030 sq in.) while the pressurized fuel in the injection chamber 20 acts on a hydraulic surface area of approximately 13.9 mm² (approx. 0.022 sq in.) area of the check valve stem 38 minus area of the needle 48 below the seat). When the pressurized fuel is drained from the pressure balancing reservoir 60 as discussed below, the balancing pressure is relieved and the check valve stem 38 is allowed to move upward and unseat the needle 48 under the upward force applied by the pressurized fuel in the injection chamber 20. To facilitate the unseating, the spring 56 is sized to provide a downward force less than this upward force. Once the needle 48 is unseated, the pressurized fuel acts on the full hydraulic surface area of the check valve stem 38 (i.e., approximately 19.6 mm²/0.030 sq in.). When the needle 48 is to be reseated to cease injecting the pressurized fuel, the pressure balancing reservoir 60 is again pressurized with the high-pressure fuel. Because the pressurized fuel in the pressure balancing reservoir 60 and the injection chamber 20 act in the same size hydraulic surface areas with the needle 48 unseated, the forces balance and cancel each other, and the needle 48 moves back to the seated position under the biasing force of the spring 56.

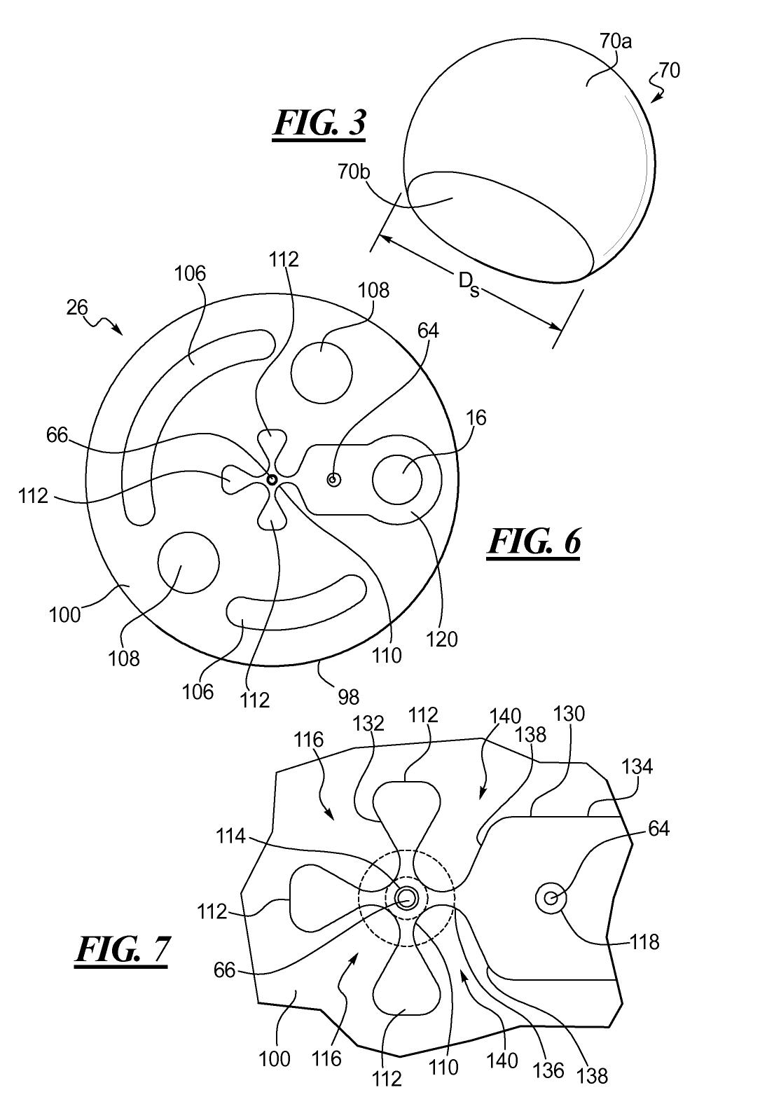

The pressurized fuel is drained from the pressure balancing reservoir 60 via a balance pressure relief orifice 66 through the orifice plate 26. The drainage of fuel through the balance pressure relief orifice 66 is controlled by a two-way solenoid valve 68 that operates to cause a spherical member or ball 70 to alternately engage a valve seat of the orifice plate 26 to prevent fluid flow and disengage from the valve seat to allow drainage. As seen in greater detail in FIG. 3, the ball 70 has a spherical portion 70a and planar seating portion 70b that will engage the valve seat of the orifice plate 26. The spherical portion 70a permits the ball 70 to rotate and self-align with the valve seat to ensure full contact between the valve seat and the seating portion 70b. The seating portion 70b has an associated diameter Dₛ that will combine with the geometry of the seating surface to determine the contact area between the seating portion 70b and valve seat as will be discussed more fully below.

Returning to FIG. 1, the ball 70 maybe disposed within a recess of an armature pin 72 extending upwardly within an axial bore 74 of the valve body 24 to an armature 76 disposed within an armature housing 78. The armature pin 72 may be biased downwardly by a spring 80 disposed between a collar 82 mounted on the armature pin 72 and a spacer 84 that may be fixed such that the spacer 84 remains stationary with respect to the valve body 24. The armature 76 is disposed proximate a solenoid 86 of the solenoid valve 68 such that the armature 76 may be influenced by a magnetic field created by the solenoid 86. When the solenoid 86 is not actuated, the armature 76 and armature pin 72 are forced downwardly by the biasing force of the spring 80 such that the seating portion 70b of the ball 70 engages the valve seat of the orifice plate 26 to seal the pressure balancing reservoir 60. When the solenoid 86 is actuated, the armature 76 is pulled upwardly by the magnetic field generated by the solenoid 86, and the armature pin 72 is lifted upward such that the ball 70 is unseated by the pressurize fuel in the balance pressure relief orifice 66 to allow the fuel to drain from the pressure balancing reservoir 60.

During normal operation of the fuel injector 10, the solenoid valve 68 is actuated and de-actuated at a high frequency such that heat is generated within the valve body 24 by the electric current in the solenoid 86 and the reciprocating motion of the armature 76 and armature pin 72. To regulate the temperature within the valve body 24, coolant may be provided at a coolant inlet 88. The coolant inlet 88 is placed in fluid communication with the axial bore 74 of the valve body 24 by a low-pressure fluid passage 90. Once in the axial bore 74, the coolant circulates around, among other components, the armature pin 72, armature 76, armature housing 78, spring 80, collar 82 and spacer 84 to draw heat from the components. After absorbing heat, the coolant exits the axial bore 74 via a second low-pressure fluid passage 92 to a drain reservoir 94 in the nozzle case 22 before flowing out of the fuel injector 10 through drain orifices 96.

The drain reservoir 94 also provides an outlet for the high-pressure fuel released through the balance pressure relief orifice 66 when the ball 70 is unseated. Referring back to FIG. 2, a top surface of the orifice plate 26 may have a configuration of raised seats providing grooves or passages for the fuel from the balance pressure relief orifice 66 to flow over the top surface to the edges of the orifice plate 26 and into the drain reservoir 94. FIGS. 4 and 5 illustrate an embodiment of the orifice plate 26 configured for drainage of fuel into the drain reservoir 94. The orifice plate 26 may have an annular outer surface 98 and a generally planar top surface 100. The high-pressure fuel passage 16, balance pressure orifice 64 and balance pressure relief orifice 66 may extend through the orifice plate 26 from the top surface 100 through the bottom surface to provide fluid flow as described above, and the balance pressure relief orifice 66 may be disposed at a longitudinal axis of the orifice plate 26. The top surface 100 may include a raised valve seat 102 encircling the balance pressure relief orifice 66, a raised valve body seat 104 encircling both the high-pressure fuel passage 16 and the balance pressure orifice 64, and one or more additional raised pads 106 providing contact areas for the valve body 24. The orifice plate 26 may further include a plurality of dowel holes 108 extending there through that may align with corresponding holes of the valve body 24 and/or the check guide plate 28 to ensure proper alignment of the components during assembly of the fuel injector 10.

The raised valve seat 102 surrounding the balance pressure relief orifice 66 may have a central seat surface 110 with a plurality of leaf portions 112 extending outwardly there from. The central seat surface 110 may include a hole 114 coaxial with the balance pressure relief orifice 66 and may have a larger diameter than the inner diameter of the balance pressure relief orifice 66 such that the hole 114 may appear to be counter bored or countersunk. The increased diameter of the hole 114 may allow implementation of the orifice plate 26 in fuel injectors 10 with balance pressure relief orifices 66 of differing sizes up to the diameter of the hole 114 without affecting the performance of the solenoid valve 68 by providing a constant surface area upon which the high-pressure fuel acts. The leaf portions 112 extend outwardly from the central seat surface 110, and have widths W_{L} that may be relatively narrow proximate the central seat surface 110 and increase as the radial distance from the central seat surface 110 increases. The leaf portions 112 extend for a distance from the central seat surface 110, but terminate along the top surface 100 inward of the annular outer surface 98.

The intersection of the central seat surface 110 and adjacent leaf portions 112 may have a radius of curvature R defining a curved surface there between so that a generally continuous, uninterrupted edge may be formed around the perimeter of the valve seat 102. The spaces between adjacent leaf portions 112 may form drainage channels 116 extending outwardly from the central seat surface 110. When the ball 70 is unseated, the high-pressure fuel from the pressure balancing reservoir 60 may flow over the central seat surface 110, down into the drainage channels 116, over the top surface 100 and off the outer edge of the orifice plate 26 into the drain reservoir 94. In the illustrated embodiment, the leaf portions 112 may be dimensioned such that the width W_{C} of the drainage channels 116 increases as the radial distance from the central seat surface 110 increases. Increasing the width of the drainage channels 116 correspondingly increases the volume of the drainage channels 116 so that the velocity of the draining fuel decreases as it flows outwardly from the balance pressure relief orifice 66.

As discussed above, the valve body seat 104 encircles the high-pressure fuel passage 16 and the balance pressure orifice 64. By providing a continuous raised surface between the high-pressure fuel passage 16 and the balance pressure orifice 64, the valve body seat 104 and high-pressure fuel balancing passage 62 form a closed channel placing the high-pressure fuel passages 14, 16 in fluid communication with the balance pressure orifice 64 when the valve body 24 and orifice plate 26 are aligned and in contact with each other. As with the valve seat 102 and balance pressure relief orifice 66, the valve body seat 104 may include a hole 118 coaxial with balance pressure orifice 64 and having a larger diameter than the inner diameter of the balance pressure orifice 64.

In the embodiment shown in FIGS. 4 and 5, the valve seat 102 may be oriented with one of the drainage channels 116 opening toward the valve body seat 104. With this orientation, high-pressure fuel draining from the balance pressure relief orifice 66 and into that particular drainage channel 116 will flow into an inward surface 120 of the valve body seat 104. To facilitate flow of the draining fuel and to prevent cavitation of the fuel as it impacts the inward surface 120, the inward surface 120 presents a generally convex shape toward the corresponding drainage channel 116. In the illustrated embodiment, the inward surface 120 has a rounded center portion and generally flat lateral portions that direct the draining fuel around the valve body seat 104 and toward the annular outer surface 98 of the orifice plate 26. Of course, other convex geometries may be implemented for the inward surface 120 of the valve body seat 104 that will facilitate drainage of the fuel and reduce or eliminate cavitation of the draining fluid at the inward surface 120, and such geometries are contemplated by the inventors as having use in orifice plates in accordance with the present disclosure.

As a further example, FIGS. 6 and 7 illustrate an alternative embodiment of the orifice plate 26 having a combined valve and valve body seat 130. For purposes of clarity and brevity, similar components of the combined valve and valve body seat 130 will be identified using the same reference numerals as the corresponding components of the valve seat 102 and valve body seat 104 of FIGS. 4 and 5. The combined valve and valve body seat 130 may have a valve seat portion 132 and a valve body seat portion 134 that are generally similar to the valve seat 102 and valve body seat 104 as discussed above. Leaf portions 112 extend outwardly from a central seat surface 110 and define drainage channels 116 there between. The valve body seat portion 134 encircles both the high-pressure fuel passage 16 and the balance pressure orifice 64. In the present embodiment, the valve seat portion 132 is rotated approximately 45° with respect to the orientation of the valve seat 102, with an isthmus 136 of material connecting the seat portions 132, 134. Inward surfaces 138 of the valve body seat portion 134 proximate the valve seat portion 132 combine with the corresponding leaf portions 112 to define drainage channels 140 directing the draining fuel toward the annular outer surface 98 of the orifice plate 26. In the illustrated embodiment, the inward surfaces 138 may be approximately parallel to the walls of the leaf portions 112 defining the opposite boundary of the drainage channels 140 such that the drainage channels 140 have constant widths and cross-sectional areas after the initial rounded inners surface at the central seat surface 110. However, if desired, the inward surfaces 138 may be oriented and/or have a curvature such that the distance between the inward surfaces 138 and the walls of the corresponding leaf portions 112 increases as the radial distance from the central seat surface 110 increases, thereby causing a decrease in the velocity of the fuel as is flows outwardly toward the annular outer surface 98 of the orifice plate. It will be apparent to those skilled in the art that the illustrated and discussed configurations of the inward surfaces 138 will minimize or eliminate cavitation of the fuel as is flows through the drainage channels 140.

### INDUSTRIAL APPLICABILITY

The foregoing invention finds utility in various industrial applications, such as in internal combustion engines where fuel injectors are actuated for hundreds or thousands of cycles per second. In such environments, the space allocated for the fuel injectors may be limited, and it may be desirable to operate efficiently in terms of the size of the components of the fuel injector and the amount of energy required to operate the fuel injector. The useful life of the fuel injector is also important, as the engines within which the fuel injectors are installed are expected to operate for thousands of hours with minimal maintenance.

In the present design, the configuration of the valve seats 102, 130 and the ball 70 allow the sizes of the solenoid valve 68 and corresponding spring 80 to be minimized while still providing a sufficient seal when the seating portion 70b of the ball 70 engages the valve seat 102, 130. The design also facilitates drainage of the pressurized fuel with creating undesirable cavitation. The spring 80 must provide sufficient force to hold the ball 70 tightly seated against the valve seat 102, 130 when high-pressure fuel is provided to the pressure balancing reservoir 60. The amount of force required to hold the ball 70 in place against the high-pressure fuel is determined by the pressure of the fuel in the pressure balancing reservoir 60 and the diameter of the hole 114, and the sealing pressure applied by the spring 80 at the valve seat 102, 130 is determined by the size of the surface contact area between the seating portion 70b and the valve seat 102, 130. The amount of pressure applied to the contact area is inversely proportional to the size of the contact area. Consequently, the same spring force applies greater pressure to a smaller contact area, thereby forming a tighter seal to prevent leakage from the pressure balancing reservoir 60.

In view of this, the central seat surface 110 and the leaf portions 112 in accordance with the present disclosure may be dimensioned to reduce to the contact area with the planar seating portion 70b of the ball 70, and correspondingly reduce the size of the spring 80 required to seat the ball 70 and the size of the solenoid 86 required to unseat the ball 70 against the force of the spring 80. In one exemplary implementation, the fuel injector 10 may have a maximum operating pressure of approximately 250 MPa (approx. 36.3 kpsi), while the hole 114 at the surface of the valve seat 102, 130 may have an inner diameter of approximately 0.45 mm (approx. 0.018 in.). When the ball 70 is seated and the pressure balancing reservoir 60 is pressurized at the maximum operating pressure, the pressurized fuel acts on an area of approximately 0.16 mm² (approx. 0.0002 sq in.), resulting in an upward force of approximately 40 N (approx. 9.0 lb. force) being exerted on the ball 70 by the high-pressure fuel. A spring force greater than 40 N (9.0 lb. force) must be applied by the spring 80 to overcome the fluid pressure and seat the ball 70, but a substantially greater force should be used to prevent leakage. Consequently, the spring 80 may be selected to apply an assembled load of approximately 125 N (approx. 28.1 lb. force).

The diameter D_{S} of the planar seating portion 70b of the ball 70 may be approximately 2.0 mm (approx. 0.079 in.), while the diameter of the central seat surface 110 may be considerably smaller with a value of approximately 0.8 mm (approx. 0.031 in.). The balance pressure relief orifice 66 may have a diameter in the range of 0.2-0.3 mm (0.008-0.012 in.) Consequently, when the ball 70 is seated and the contact area between the planar seating portion 70b and the central seat surface 110 is approximately 0.34 mm² (approx. 0.0005 sq in.). Additional contact area is added by the leaf portions 112, but the amount is minimized by having the width W_{L} minimized proximate the central seat surface 110 as shown in the drawings. The width W_{L} may range from a minimum of approximately 0.30 mm (approx. 0.012 in.) proximate the central seat surface 110 to approximately 0.51 mm (approx. 0.020 in.) at a distance of approximately 1.0 mm (approx. 0.039 in.) from the center of the balance pressure relief orifice 66, which approximately coincides with the distance to the outer edge of the planar seating portion 70b of the ball 70. The dimensions provide a contact area between the planar seating portion 70b and the valve seat 102, 130 of approximately 1.138 mm² (approx. 0.0018 sq in.). With a spring force of 125 N (28.1 lb. force), the spring 80 provides a sealing pressure of approximately 110 MPa (approx. 16.0 kpsi) to make a substantially leak-proof seal when the ball 70 is seated. A larger contact area would require a correspondingly larger spring force to achieve the same sealing pressure. With the pressurized fluid generating an approximately 40 N (approx. 9.0 lb. force) force, and the spring 80 providing an approximately 125 N (approx. 28.1 lb. force) force, the solenoid 86 must generate an upward force of greater than 85 N (19.1 lb. force) to overcome the spring force and unseat the ball 70.

Those skilled in the art will understand that foregoing is one example of an implementation of an orifice plate 26 in accordance with the present disclosure, and application of such orifice plates 26 in fuel injectors 10 having differing dimensions and operating pressures are contemplated by the inventors. Moreover, other configurations of the orifice plate 26 are contemplated. For example, in some implementations, the high-pressure fuel passage 18 and/or the balance pressure orifice 64 may be provided in components other than the orifice plate 26 while still placing the pressure balancing reservoir 60 in fluid communication with the high-pressure fuel inlet 12. In such implementations, the valve body seat 104 or valve body seat portion 134 may be reconfigured or eliminated due to the absence of one or both of the high-pressure fuel passage 18 and balance pressure orifice 64.

While the preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fail within the scope of the claims defining the invention.

What is claimed is:

1. A pressure balancing orifice plate for a fuel injector device, comprising:
a cylindrical body having a top surface, a bottom surface, an annular outer surface, and a body longitudinal axis;
a balance pressure relief orifice extending from the top surface to the bottom surface; and
a raised valve seat extending upwardly from the top surface and surrounding the balance pressure relief orifice, the valve seat having a central seat surface encircling the balance pressure relief orifice and a plurality of leaf portions extending radially outwardly from the central seat surface and defining drainage channels there between, wherein a width W_{C} of the drainage channels increases as the radial distance from the balance pressure relief orifice increases.

2. The pressure balancing orifice plate according to claim 1, comprising:
a high-pressure fuel passage extending from the top surface to the bottom surface; and
a balance pressure orifice extending from the top surface to the bottom surface.

3. The pressure balancing orifice plate according to claim 2, comprising a raised valve body seat extending upwardly from the top surface and surrounding the high-pressure fuel passage and the balance pressure orifice.

4. The pressure balancing orifice plate according to claim 3, wherein one of the drainage channels extends toward the valve body seat, and wherein the valve body seat has an inward surface facing the drainage channel and presenting a generally convex shape toward the drainage channel to direct fluid flowing through the drainage channel around the valve body seat.

5. The pressure balancing orifice plate according to claim 3, wherein the valve seat and the valve body seat intersect to form a combined valve and valve body seat.

6. The pressure balancing orifice plate according to claim 1, wherein the central seat surface has a diameter of approximately 0.8 millimeters.

7. The pressure balancing orifice plate according to claim 1, wherein a width W_{L} of the leaf portions increases as the radial distance from the balance pressure relief orifice increases.

8. A fuel injector, comprising:
a check needle for controlling flow of fuel into a combustion chamber;
a pressure balancing reservoir having pressurized fuel therein that urges the check needle toward a closed fuel blocking position; and
a control valve assembly comprising:
a pressure balancing orifice plate having a balance pressure relief orifice extending from a top surface to a bottom surface of the pressure balancing orifice plate, and having a raised valve seat extending upwardly from the top surface and surrounding the balance pressure relief orifice, wherein the balance pressure relief orifice is in fluid communication with the pressure balancing reservoir, and wherein the raised valve seat has a central seat surface encircling the balance pressure relief orifice and a plurality of leaf portions extending radially outwardly from the central seat surface and defining drainage channels there between; and
a valve member having a planar surface configured to engage the raised valve seat and form a seal there between to prevent fluid flow through the balance pressure relief orifice, wherein the valve member selectively controls a flow of pressurized fuel from the pressure balancing reservoir to a drain so that the pressurized fuel maintains the check needle in the closed fuel blocking position when the valve member forms the seal between the valve member and the valve seat, and the pressurized fuel drains through the balance pressure relief orifice to allow the check needle to move to an open fuel injection position when the valve member is disengaged from the valve seat.

9. The fuel injector according to claim 8, wherein the pressure balancing orifice plate has a high-pressure fuel passage extending from the top surface to the bottom surface, a balance pressure orifice extending from the top surface to the bottom surface and placing the high-pressure fuel passage in fluid communication with the pressure balancing reservoir to supply the pressurized fuel to the pressure balancing reservoir, and a raised valve body seat extending upwardly from the top surface and surrounding the high-pressure fuel passage and the balance pressure orifice.

10. The fuel injector according to claim 9, wherein one of the drainage channels extends toward the valve body seat, and wherein the valve body seat has an inward surface facing the drainage channel and presenting a generally convex shape toward the drainage channel to direct pressurized fuel flowing through the drainage channel around the valve body seat.

11. The fuel injector according to claim 9, wherein the valve seat and the valve body seat intersect to form a combined valve and valve body seat.

12. The fuel injector according to claim 8, wherein the central seat surface has a diameter of approximately 0.8 millimeters.

13. The fuel injector according to claim 8, wherein a width W_{L} of the leaf portions increases as the radial distance from the balance pressure relief orifice increases.

14. The fuel injector according to claim 9, wherein a width W_{C} of the drainage channels increases as the radial distance from the balance pressure relief orifice increases.

15. A fuel injector system for use in an internal combustion engine, comprising:
a high-pressure fuel source;
an injection chamber in fluid communication with the high-pressure fuel source;
a check needle for controlling flow of pressurized fuel from the injection chamber into a combustion chamber;
a pressure balancing reservoir in fluid communication with the high-pressure fuel source, wherein pressurized fuel therein urges the check needle toward a closed fuel blocking position; and
a control valve assembly comprising:
a pressure balancing orifice plate having a balance pressure relief orifice extending from a top surface to a bottom surface of the pressure balancing orifice plate, and having a raised valve seat extending upwardly from the top surface and surrounding the balance pressure relief orifice, wherein the balance pressure relief orifice is in fluid communication with the pressure balancing reservoir, and wherein the raised valve seat has a central seat surface encircling the balance pressure relief orifice and a plurality of leaf portions extending radially outwardly from the central seat surface and defining drainage channels there between; and
a valve member having a planar surface configured to engage the raised valve seat and form a seal there between to prevent the pressurized fuel from flowing through the balance pressure relief orifice, wherein the valve member selectively controls flow of pressurized fuel from the pressure balancing reservoir to a drain so that the pressurized fuel maintains the check needle in the closed fuel blocking position when the valve member forms the seal between the valve member and the valve seat, and the pressurized fuel drains through the balance pressure relief orifice to allow the check needle to move to an open fuel injection position when the valve member is disengaged from the valve seat.

16. The fuel injector system according to claim 15, wherein the pressure balancing orifice plate has a high-pressure fuel passage extending from the top surface to the bottom surface, a balance pressure orifice extending from the top surface to the bottom surface and placing the high-pressure fuel passage in fluid communication with the pressure balancing reservoir to supply the pressurized fuel to the pressure balancing reservoir, and a raised valve body seat extending upwardly from the top surface and surrounding the high-pressure fuel passage and the balance pressure orifice.

17. The fuel injector system according to claim 16, wherein one of the drainage channels extends toward the valve body seat, and wherein the valve body seat has an inward surface facing the drainage channel and presenting a generally convex shape toward the drainage channel to direct pressurized fuel flowing through the drainage channel around the valve body seat.

18. The fuel injector system according to claim 16, wherein the valve seat and the valve body seat intersect to form a combined valve and valve body seat.

19. The fuel injector system according to claim 15, wherein the central seat surface has a diameter of approximately 0.8 millimeters.

20. The fuel injector system according to claim 15, wherein a width W_{L} of the leaf portions increases as the radial distance from the balance pressure relief orifice increases.

21. The fuel injector system according to claim 15, wherein a width W_{C} of the drainage channels increases as the radial distance from the balance pressure relief orifice increases.
